(19) United States
(12) Patent Application Publication
(10) Pub. No.: US 2004/0181491 A1
(43) Pub. Date: Sep. 16, 2004

(54) Method, computer equipment and a program for planning of electric power generation and electric power trade

(75) Inventors: Yasuo Sato, Tokyo (JP); Yasushi Harada, Tokyo (JP); Toshiyuki Sawa, Tokyo (JP); Mitsuo Tsurugai, Tokyo (JP); Shigeru Tamura, Tokyo (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD.

(21) Appl. No.: 10/697,451

(22) Filed: Oct. 30, 2003

(30) Foreign Application Priority Data
Mar. 12, 2003 (JP) 2003-065872

(51) Int. Cl. G06F 17/60

(52) U.S. Cl. 705/63

(57) ABSTRACT

A method, equipment and a program that present uncertain factors such as the demand variation of electric power, electric power unit price and fuel unit price in stochastic models, provide the analytical means of the correlation between return and risk by which the results can be quantitatively given, have GUI means to do trail and error evaluation of the combinations of various conditions regarding to the interrupt operation plan and electric power trade contract plan and have an amendment means by which the amendment of plans is cooperated with the analytical means of the correlation between return and the risk has been proposed. The system enables to comprehend the correlation between returns and risk that the present operating schedule involves.

### FIELD OF THE INVENTION

This invention relates to a method, computer equipment and a program for planning of electric power generation and trade, especially to planning system to evaluate the power demands and cost-return balances and assist to make the optimum plans for the generator operations and the electric power trade contracts.

### BACKGROUND OF THE INVENTION

In the conventional electric power utility management system, such as U.S. Pat. No. 6,021,402, the management is carried out based on an event tree prescribed by probability of uncertainty of the electric power trading prices and the volume dealt in the exchange which is a wholesales market of electric power.

Reference 1

U.S. Pat. No. 6,021,402

In this invention, it is possible to automatically make the power generator operation schedule that maximizes the expected return by using supposed probability scenarios of power supply alternatives, power demands and other financial matters. However the resultant solution obtained by focusing the maximum return has no assessments regarding the correlation between the risk immunity and the improvement of return, therefore the solution lends to provide “a high risk and high return” operation schedule of tho power generators.

For the long-term planning such as monthly planning or annually planning, it is quite important to grasp and comprehend the subjective correlation between the risk and return. By analyzing the uncertainty of the return and specifying the term when such uncertainty is expected, it is requested to find the opportunities to agree long term and firm bilateral sales contracts and/or to accommodate the schedules of the interference inspections or stops of the power stations into the regular operation program. For these cases, it is not sufficient to settle a plan to satisfy a single evaluation function to assess the achievement of the minimum operation cost but important to make a plan that optimizes the trade-off balancing and harmonizing with the expected return and the variance of the return. The tolerance of the return substantially depends of the financial circumstance of the firms that run the power plant. The financial elements vary for every moment and therefore the tolerance of the return is not coherently decided over all moments.

Therefore, it is important to make comprehensive plans that cover those of operation of power generators and power station facilities and electric power trade plans (such as bilateral procurement and exchange procurement) by assessing the return risk correlation based of the existence of the seasonal and time deviations as well as explicitly including the uncertainty or time variations in the electric power demand and the fuel unit price.

### SUMMARY OF THE INVENTION

The advantages of the present invention provide a method, computer equipment and a program to a power generation plan and an electric power trade contract plan that grasp, comprehend and assess the correlation between the return and risk that potentially held thereof.

One of the specific advantages of the present invention is that the balance of the revenue and the expenditure obtained by power generation and the electric power trade is assessed by the analytical process of the probability distribution that represents the uncertainty factors and is presented in a form of time series presentation as the time-varying probability distribution.

The other specific advantages of the present invention will be explained in the detail discussion of the following embodiments.

### BRIEF DESCRIPTION OF THE DRAWINGS

FIG. 1 is an example of schematic that shows a process flow that makes the power generation plan and power generation trade plan regarding to the present invention.

FIG. 2 shows an example of the input data formal of Operation Request for Power Station as shown in FIG. 1.

FIG. 3 shows an example of the data format of Electric Power Trade Contract Plan as shown in FIG. 1.

FIG. 4 shows an example of the data format of Electric Power Demand Plan as shown in FIG. 1.

FIG. 5 shows an example of a process to make the data of Initial Value Generation Computation for Power Generator Operating Program and Electric Power Trade Contract Program as shown in FIG. 1.

FIG. 6 shows an example of the process for the stop of Stochastic Process Scenario Generation as shown in FIG. 1.

FIG. 7 shows an example of data format of stochastic process model that generate scenarios as shown in FIG. 1.

FIG. 8 shows an example of data format of the Fuel Unit Price Scenario as shown in FIG. 1.

FIG. 9 shows an example data format of the Demand Variation Scenario as shown in FIG. 1.

FIG. 10 shows an example of the process for the step of Return Distribution Transition Analysis as shown in FIG 1.

FIG. 11 shows an example of the table of Analytical Results as shown in FIG. 10.

FIG. 12 shows an example of the chart shown in the display presentation of Power Generation Plan/Power Generation Trade Plan and Return Distribution Transition Diagram as shown in FIG. 1.

FIG. 13 shows another example of the chart shown in the display presentation of Power Generation Plan/Power Generation Trade Plan and Return Distribution Transition Diagram.

FIG. 14 shows another example of the chart shown in the display presentation of Power Generation Plan/Power Generation Trade Plan and Return Distribution Transition Diagram.

FIG. 15 shows an example of computer equipment.

FIG. 16 shows a removable magnetic disc.

FIG. 17 shows a CD ROM.

### DETAILED DESCRIPTION OF A PREFERRED EMBODIMENT OF THE INVENTION

When the principle of market competition would be introduced into the electric power trade market, the market participants would be exposed to various risks in various business aspects. It would be quite necessary to have countermeasures against the customer losses and demand variation, the resultant excess and loss of fuel procurement, the unit prices of the fuel and that of the electric power in accordance with the electric power trade.

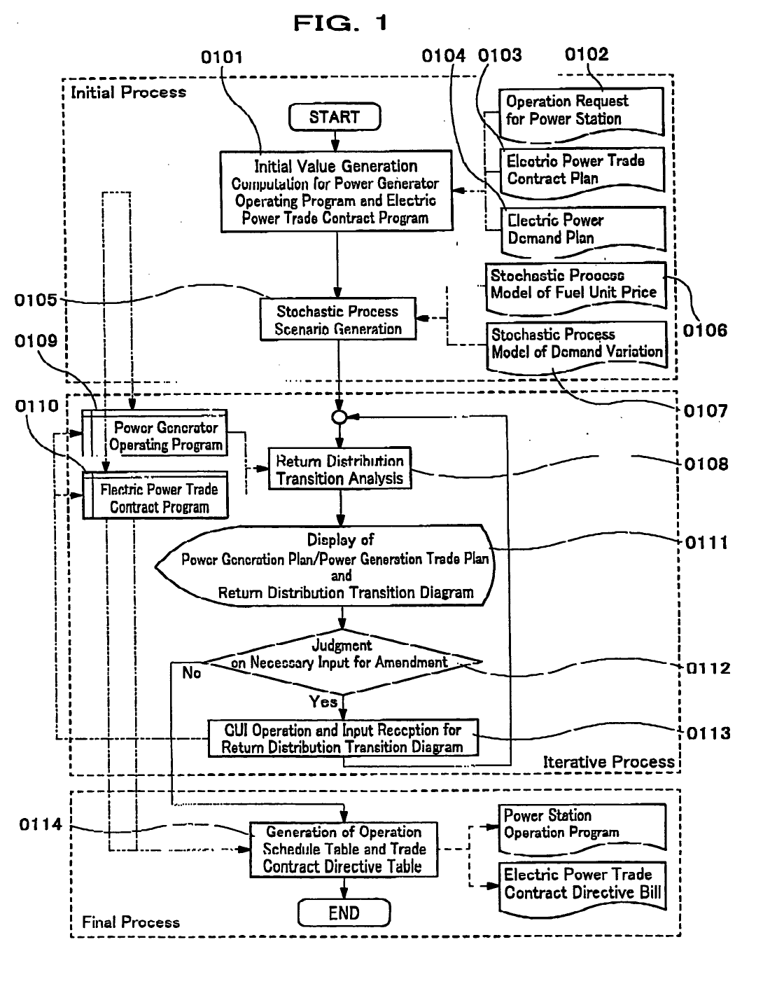

FIG. 1 shows a process flow of a power generation plan and an electric power trade contract plan that is an embodiment of the present invention. The method according to this process realizes a function to analyze the correlation between the return and the risk in various moments with regard to adjusting power generator operating time and the electric power trade contract term and a function to evaluate the effect of amendments of the plan in a manner of trial and error. The operator who operates this system can obtain the service of such resultant services.

In the above process flow, several data are computed in the initial process. At the step of Initial Value Generation Computation for Power Generator Operating Program and Electric Power Trade Contract Program 0101 (abbreviated as “step 0101”, hereinafter), the data of Operation Request for Power Station 0102, Electric Power Trade Contract Plan 0103, Electric Power Demand Plan 0104 are read and validated for the compliance with the fundamental data rules in order to compute the initial values of Power Generator Operating Program and Electric Power Trade Contract Program. The data of Operation Request for Power Station 0102 are those of assembled data of operation program for each generator with regard to periodical maintenance inspections and testing operations that need the output restriction of the power generator.

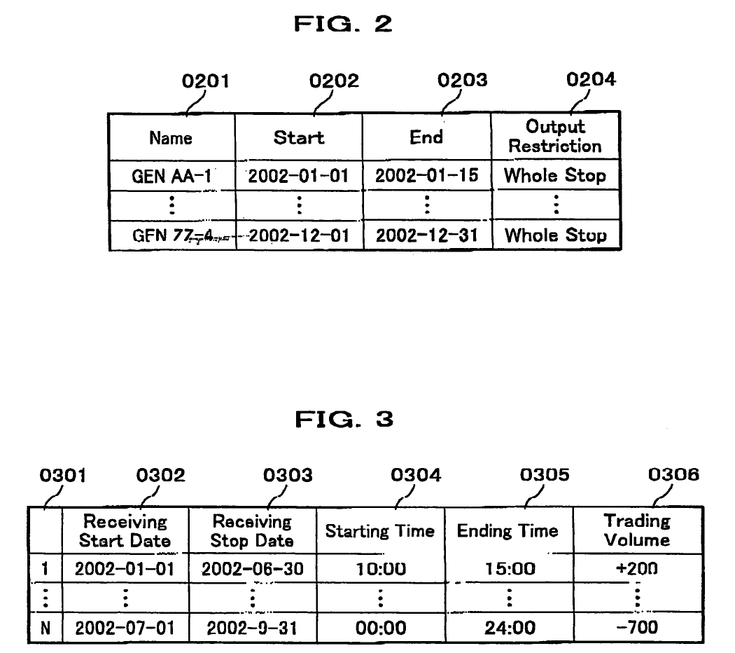

FIG. 2 shows an example of the input data format of Operation Request for Power Station 0102. Name 0201 of control items, Start 0202 of operation date, End of operation date and output. Restriction 0204 of generator operation restriction are described in a data table of the input data format. For the presentation of Output Restriction, quantitative values as 100% restriction of 10% restriction are given. The information of the same generator can be entered in multiple of times in the data table of the data format.

FIG. 3 shows an example of the data format of Electric Power Trade Contract Plan. The data of Electric Power Trade Contract Plan 0103 are those of assembled data of long-term program of each contracted supply which is mainly agreed under a bilateral sales contract. The format is given in a data table as being similar to FIG. 2 and Number 0301 of control item, Receiving start Date Time 0302 or starting day to receive the electric power supply, Receiving Stop Date 0303 of stopping day to stop to receive the electric power supply and time zone columns that show Starting Time 0304 And Ending Time 0305 to receive the electric power supply are formatted in the data table. For example, a contract to supply the electric power only in the time zone of peak power consumption from 10:00 to 15.00 o'clock in day time is described as shown in the first row of the data table. The day-base supply contract is described as shown in the N-th row of the data table. A power supply contract that has different levels of supplies for the day time and the night time can be arbitrarily described by using a combination of plural rows in the data table as shown in FIG. 3.

FIG. 4 shows an example of the data format of Electric Power Demand Plan 0104. Electric Power Demand Plan 0104 is assembled data of power supply forecast supposed at the present time. For each of Date 0401 and Time 0402, Expected Demand 0403 (which is a forecasted demand of the electric power) and Reserved Power 0403 which is a reserve for supply are described in this data table.

By using the data of Operation Request for power Station 0102, those of Electric Power Trade Contract Plan 0103 and those of Electric Power Demand Plan 0104, the step 0101 executes Initial Value Generation Computation for Power Generator Operating Program and Electric Power Trade Contract Program. In principle, Operation Request for Power Station and Electric Power Trade Contract Plan are to be complied in accordance with Electric Power Demand Plan specified by the information given in the data table of the Electric Power Demand Plan. According, the information of Operation Request for Power Station can be exploited for the data of Power Generator Operating Program as is entered to Operation Request for Power Station. The compliance between two sets of these data as Power Generator Operating Program and Operation Request for Power Station is checked for the purpose of confirmation in this step 0101.

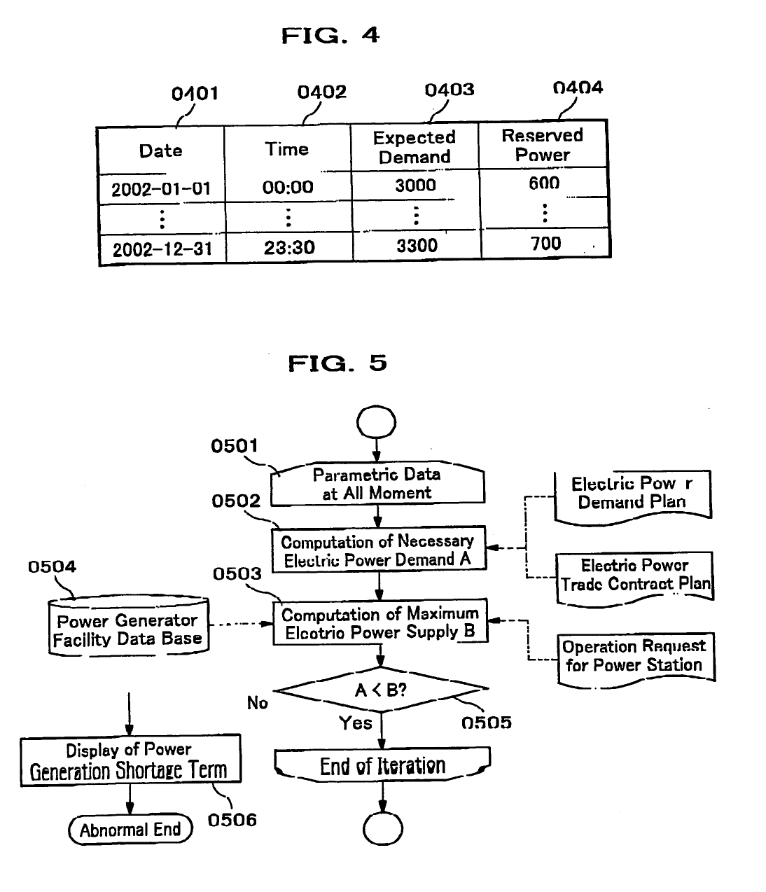

The flow as shown in FIG. 1 is implemented as shown in FIG. 5 and the detail contents of the flow will be explained by using FIG. 5 as follows. The data of Initial Value Generation Computation for Power Generator Operating Program and Electric Power Trade Contract Program are read and validated for the compliance with a certain rule as described below prior to the computation regarding to a power generation plan and an electric power trade contract plan over all moments covering the term to be scheduled. At the step 0502, Necessary Electric Power Demand A is computed by summation of Expected Demand and the delivery volume Specified in the Electric Power Trade Contract as a contracted buying electric power. At top 0503, all of the electric power volume given by the operatable power generators is summed up to be Maximum Electric Power Supply B based on Operation Request for Power Station at the moment concerned. The flow of this computation is accompanied with a judgment step 0505 to check whether the condition A<B is satisfied and the flow is iterated to cover all of the moments, which is the definition of the procedure as shown in 0501. At the step 0506, the term during when the power generation is short is displayed and goes to Abnormal END if the above condition is not satisfied. The data of Operation Request for Power Station and Electric Power Trade Contract Plan that have passed this validation for compliance are adopted for Initial Value Generation Computation for Power Generator Operating Program and Electric Power Trade Contract Program and stored in a data table 0109 and 0110.

After completing the execution of Initial Value Generation Computation for Power Generator Operating Program and Electric Power Trade Contract Program 0101, Stochastic Process Scenario Generation 0105 is called out as another step of initial process. In this step, many probable data sets regarding to fuel unit price and electric power demand which are uncertain elements for the assessment are generated in a form of time-series data in the future time in order to assess the power generator operating program and electric power trade contract program by using Monte Carlo method. These forecasted future data in a form of time-series data in the future time are called “scenarios” hereinafter.

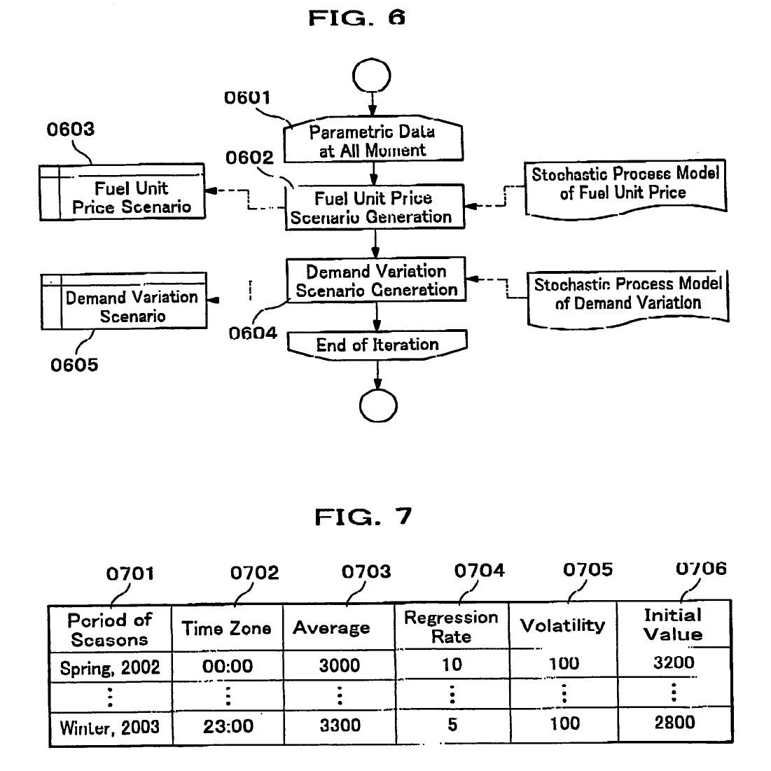

FIG. 6 shows the detail process for the step of Stochastic Process Scenario Generation 0105. The flow iteration 0601 over all moments covering the term in which future data is presented in a time-series form generates Fuel Unit Price Scenario 0603 by the step of Fuel Unit Price Scenario Generation 0602 and Demand Variation Scenario 0605 by the step of Demand Variation Scenario Generation 0604 at the same time. Both scenarios have the same amount of data as the trial times of Monte Carlo computation for the same time zones.

The stochastic model data that give these scenarios are exploited by those that prescribe Stochastic Process Model of Fuel Unit Price 0106 and Stochastic Process Model of Demand variation 0107. These stochastic model data are presented by the linear combination with system identification parameters which have been estimated using the past statistical data.

Though there are many methodologies proposed for the stochastic model regarding to the time-varying phenomena, the following autoregressive moving average model has been adopted;

dSt−α(t) (μ(t)−St)+σ(t)dω (1)

where, each symbol has the following definition;

St=ln Pt: logarithmic price at the time τ

α(t): regression velocity

μ(τ): average logarithmic price

σ(t): volatility

ω: erroneos variation defined in Gaussian distribution

d: differentiation operator

The equation (1) presents the regression relation, specifically autoregressive-moving of the logarithmic price against the average value μ(L), the regression velocity α(t) and volatility σ(t).

These parameters have been completed by a different process with using past recorded data and stored in another file as shown in FIG. 7. The electric power demand can be considered to have different model characteristics in a seasonal aspect and an in-time zone aspect. A set of definitions for Average 0703, Regression Rate 704 and Volatility 705 is given for every combination of Period of Seasons 0701 and Time Zone 0702 as explained above. In addition, Initial Value 0706 that is used for the head value of the time-series data is defined as well.

Fuel Unit Price Scenario 0603 obtained the process as shown by FIG. 6 is stored in a table form an shown in FIG. 8. Price 0803 of the fuel is complied for every Data 0801 and Time zone 0802 and is given for every time of Monte Carlo computation to make a 3D relational data formation. Demand Variation Scenario 0605 is compiled and stored as well as Fuel Unit Price Scenario 0603 in the process shown in FIG. 6.

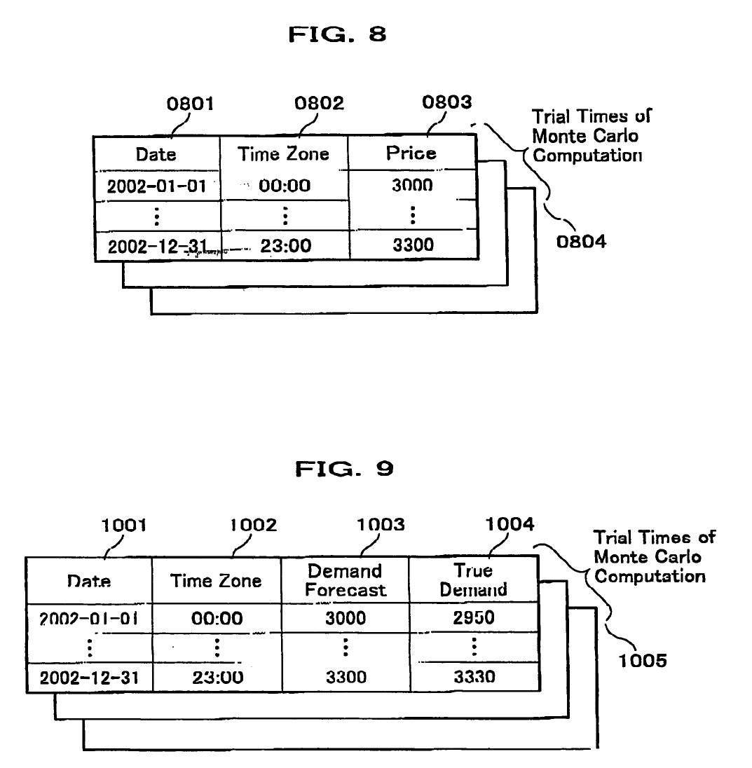

FIG. 9 shows tho data format of Fuel Unit Price Scenario 0603 as given in a table format. Demand Forecast 1003 of electric power and Actual Demand 1004 are complied for every Date 1001 and Time Zone 1002 and are given for every time of Monte Carlo computation to make a 3D relational data formulation. Demand Forecast 1003 is obtained by identification process of the system parameters computed with the predicted demand for the next day against the actual demand in such next day wherein those data are all past data. Therefore the true demand may include a prediction error against the actual value since the actual demand is regarded as a sample of the true demand.

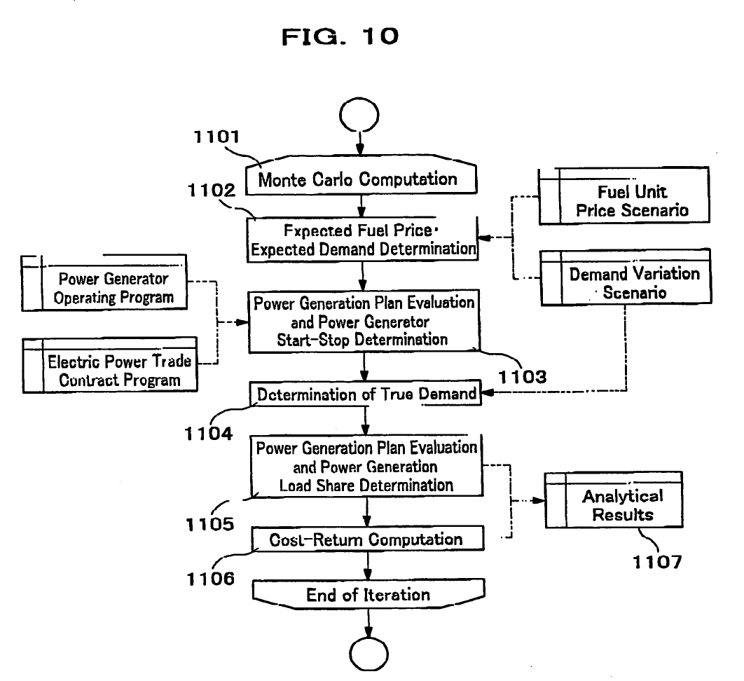

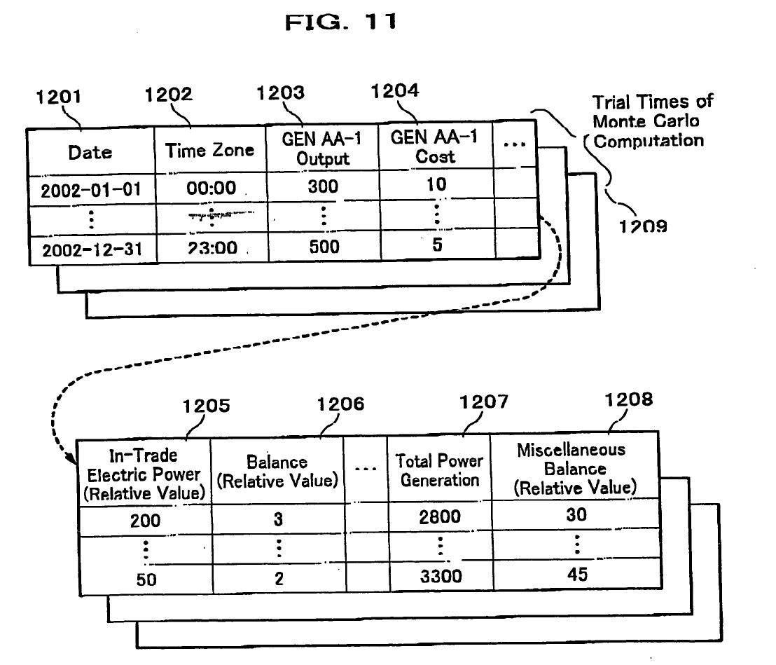

Based on initial values for Power Generator Operating Program and Electric Power Trade Contract Program obtained in the step 0101 and Fuel Unit Price Scenario 0603 and Demand Variation Scenario 0605 obtained in the step 0105, the step of Return Distribution Transition Analysis 0108 are carried out. The expectation data and the distribution are computed regarding to Power Generator Operating Program and Electric Power Trade Contract Program by using Monte Carlo method in this step. The detail of the process is shown in FIG. 10.

The step of Return Distribution Transition Analysis 0108 is carried out in a detail flow as shown In FIG. 10. The flow is iterated for the times of Monte Carlo trail computation in a loop notation as described 1101. Letting the count x as the times of iteration, the iteration starts with Expected Fuel Unit Price and Expected Demand Determination 1102. The time-series data corresponding to the counter x th data are retrieved from the data sets of time-series data complied in the same amount of data as the trial times of Monte Carlo computation as described in the Fuel Unit Price Scenario shown in FIG. 8 and the Electric Power Demand Scenario shown in FIG. 9. These are assumed to be the time-series data of the fuel unit price to be processed in this loop and the time-series data of the expected electric power demand.

In the next step as Power Generation Plan Evaluation and Fuel Generator Start Stop Determination 1103, the start-stop of power generator process is carried out for the expected power generation requirement. The expected power generation requirement in this paragraph is defined as the summation of the demand prediction designated in the above electric power demand scenario and the electric power accommodations (defined as positive for those to be adopted for other facilities) with a predetermined margin to be immune against over requirement. The algorithm to handle the problem of this power generator start-stop simulates the procedures presently used in the present central control stations of power supply. In the simulation, the above fuel unit price scenario is referred. In selecting the candidates for power generators to be integrated in the power system, the power generators that are available in such time zones are used by referring to the data of Power Generator Operating Program as shown in FIG. 2. As the result of this process, the combination with integrated generators that resultingly acquires sufficient power generation capacity is determined for each moment of the time zones against the demand prediction. In the next step 1104 of Determination of True Demand, the true value of the demand is determined. As described above, the corresponding data to the true demand is obtained based on the Demand Variation Scenario. As explained in FIG. 9, the true data of the demand may include a prediction error against the actual value of demand since the actual demand is regarded as a sample of the true demand.

At the step of Power Generation Plan Evaluation and Power Generation Load Share Determination 1105, the power generation load share determination is carried out for the true power generation requirement. The true power generation requirement in this paragraph is defined as the corrected value of the reference which is the expected power generation requirement defined in the process 1103 wherein the correction is the difference between the predicted electric power demand and the true electric power demand. The algorithm for the economical power generation load share process simulates the procedures presently used in the present central control station of power supply. An additional function can be installed such that the day trade exchange simulates a spot electric power trade of the day. The settlement price can be determined in, the most optimum share of power output load including the trade at the exchange by installing the trade as if it were one of power stations. Namely, a plan is made such that the procurement from the exchange rather alternates power generation in their own power stations.

After completing the steps 1103 and 1105 for Power Generation Plan Evaluation, the power generation load share and the combination with the power generators to be integrated are determined for the estimated scenario and the behaviors for all moments obtained in these steps. After this procedure, the return evaluation calculation of the power generation plan is carried out in Cost-Return Computation 1106. By adding the fuel amount consumed for all power generators and the fuel unit price up to account the balance of the bilateral sales contract, the required cost for each scenario and instantaneous cost for each moment can be computed.

In FIG. 11, an example of the table of Analytical Results 1107 that stores the analytical results of the balance computation. The data item 1203 of generator power output for each generator, the data item 1204 of the cost expensed for the generator, the data item 1205 of electric power which is in trade under the bilateral sales contract and the data item 1206 of the income and expenditure for each bilateral sales contract are stored against the data item 1201 of Date and the data item 1202 of Time Zone. Moreover, the data item 1207 of the total electric power generated by all properties of the generators and the data item 1208 of Miscellaneous Income and Expenditure are listed. The set of the data arranged in a time-series are generated for every time of Monte Carlo computation and it is formed in a 3D relational data base 1209.

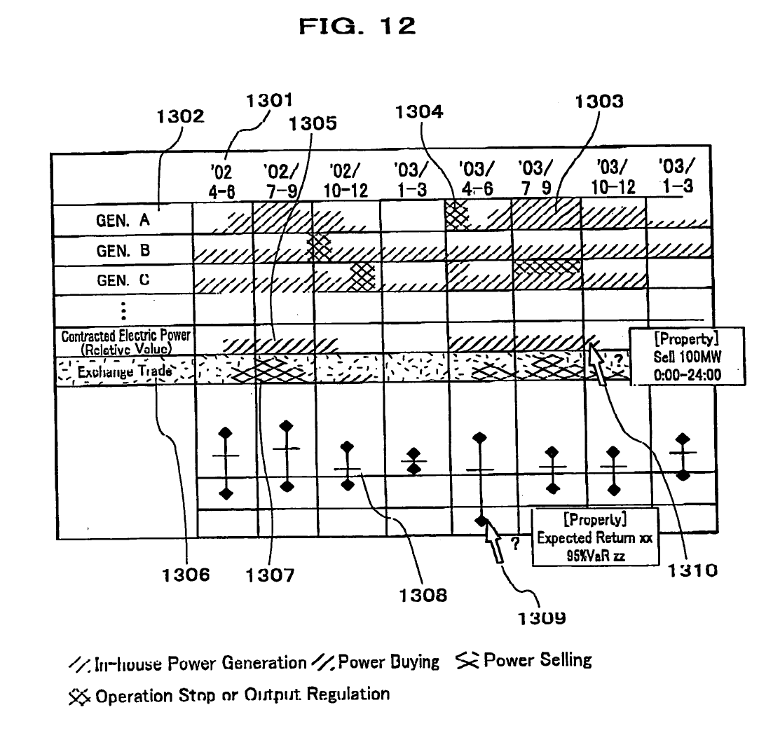

As described in the above, the step of Display of Power Generation Plan/Power Generation Trade Plan and Return Distribution Transition Diagram 0111 in the main flow as shown in FIG. 1 wherein these results are presented in GUI is carried out. FIG 12 shows the chart to be displayed.

FIG. 12 is a monthly chart to present the generator power output from each power generator and the bilateral sales contract, where the abscissa presents the monthly time and the rows the generator power output and the relative contracted electric power. The column 1302 shows all entries of generators and the generator power output generated by each generator is shown in a block 1303. The colored block 1304 in a row of a specific generator itemized in the column 1302 indicates the term of operation stops for inspections with different colors, by which the chart assists the GUI operators to be notified of the operation stops for the inspections. In the row of In-trade Electric Power, the total amount of the trade is presented. The difference of buying and selling can be notified by the colors. The trade amount that is automatically determined by the power generation plan, fuel price and settlement price of the exchange is shown in the row 1306 of Exchange Trade. The block 1306 is presented in “a meshed block” since the GUI operator cannot change the description since it is out of the GUI operator's work for the planning.

In the lowest row, the monthly results of cost-return are shown. The bar 1308 indicated at the center of vertical solid line shows the value of the expected return and the length between the round marks in the upper side and the lower side shows the variance obtained in Monte Carlo simulation. In this chart, the variance within the 5% down from the best estimation in Monte Carlo computation and 5% up from the worst estimation in Monte Carlo computation is adopted for the distribution of the balance.

GUI operator can comprehend the fundamental cash flow by monitoring the bar 1308. For example, the block 1309 which is fully colored out indicates the lowest limit of the variance as shown in 1308 is low than the lowest limit of the cash flow as the GUI designates. As shown above, the operator can clarify the problem of cash flow of the company followed by monthly time span and can study the countermeasures to solve the problems.

As the necessary information in the study of the countermeasures, a “pop-up window” is adopted in order to obtain the detail information with regard to each generator power output and the Contracted Electric Power. For example, a pop-up window is shown after selecting the detail information of GUI operation on the block 1309 and it is possible to obtain the quantitative information of the return distribution as the references. Other than these operations, the block 1303 of the accumulation of the generator power output as shown in the selection 1310, the quantitative electric power generation, the trade volume and the variation of the volume in 24 hours time frame variation (in date supply pattern) by the operation of GUI to appoint the detail presentation after the selection of the block 1305 are obtained. For example, as shown in FIG. 12, an operation environment is provided to confirm the detail information such as whether the trade is selling or buying, what is the trade volume in Wh unit, whether the contract is for in base supply or in-pack supply is provided by one action of the operation. Since the trade amount in the exchange which is automatically computed in the block 1307 has uncertainty in the trade volume, the operation environment has been provided to confirm the expectation value and the validation of the trade unit price and those of trade volume for the term as designated by the area of the selection in the pop-up windows by selecting the detail information presentation by operating GUI after selecting the block 1307.

As the result of this balance analysis, if the operator judges the cost-return relation has a problem, it is designed that the presently concerned power generation plan and electric power trade contract plan can be received at GUI Operation and Input Reception for Return Distribution Transition Diagram 0113 after selecting “Yes” in Judgment on Necessary input for Amendment. Several examples are explained using the figures in the followings.

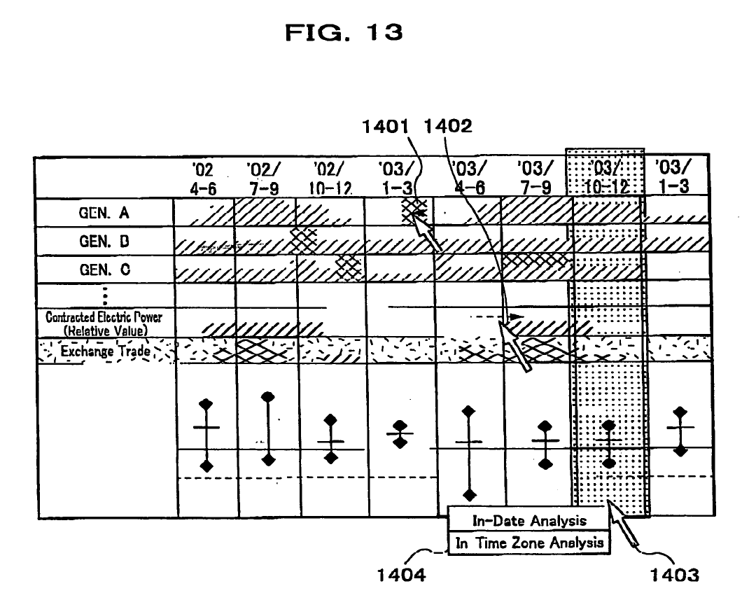

The operation 1401 in FIG. 13, a GUI operation is carried out by shifting the block indicating the term of stop of the power station due to periodic inspections into the regular operation program. By selecting this block in the GUI operation, a pop-up window that shows the term of the inspection operation and the restriction term of generator output comes out for assisting the GUI operator to understand the details. By the operation 1401, a new power generator operating plan is created as the internal data has been updated and Return Distribution Tradition Analysis of which flow details are shown in FIG. 10 is automatically executed again. By the same operation way as shown in 1402, the term of the trade contract under the bilateral sales contract and the trading volume is re-processed as shown in FIG. 10 by the GUI operation to stretch the block in height and the width that result in changing the internal data that stores the electric power trade contract plan under the bilateral sales contract. Other than these detail operations, GUI assists the operator to understand further management issues. In FIG. 13 which has an abscissa axis in the unit of month, the action enables to expand the information (drill down) as a block of a certain month by the operation 1404. For example, as shown in FIG. 13, the range that is from October ′03 to December ′03 can be expanded to see the finer information in the unit of days. Other than these operations, the concept of the time scale can be converted. For example, it is possible to check the balance calculation against the time zones in a day.

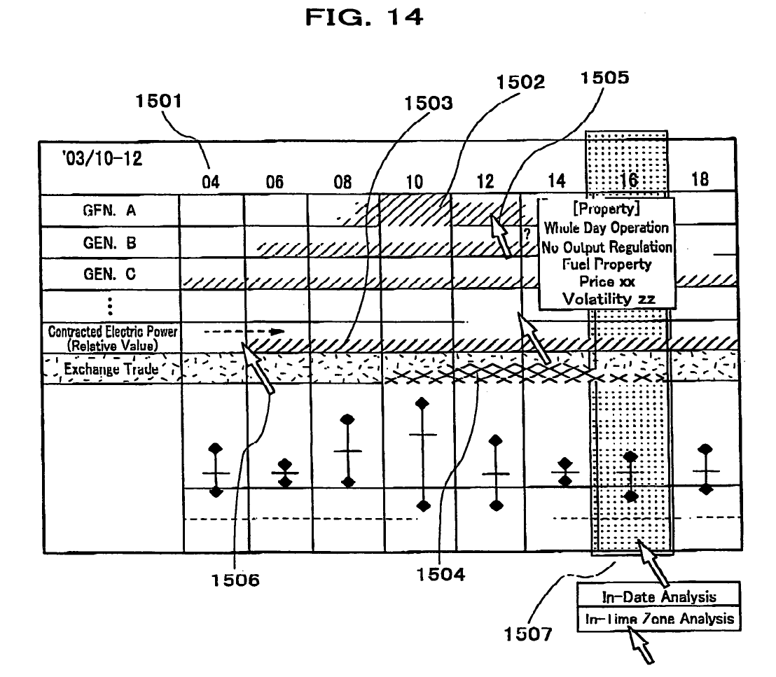

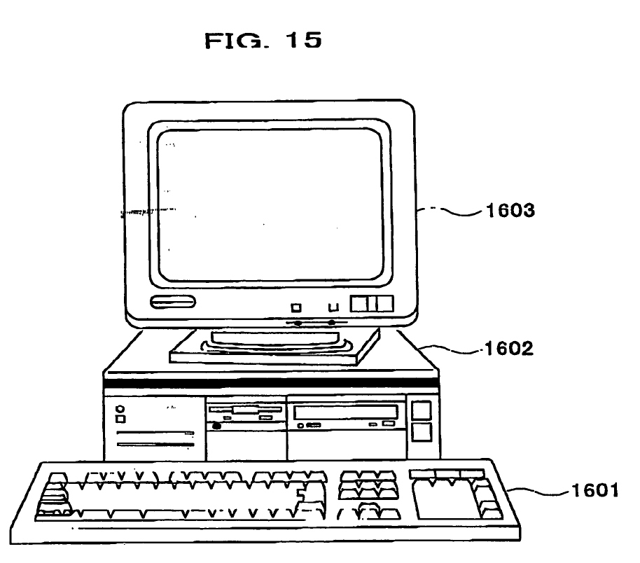

FIG. 14 shows the chart in such a way that the time zone is adopted for the horizontal axis. FIG. 14 shows the summary of the information covering the time frame for 0 to 24 o'clock. As same as in FIG. 12, the block 1502 that shows the generator power output and the block 1504 that shows the trade volume at the exchange are graphically shown. Since the expansion of the information is designated for the term of October to December of ′03, the time zone data in the averages for this term are shown in the blocks 1502 to 1504.

For the chart presented in time abscissa, it is possible to retrieve and handle the detail information as explained in FIG. 12. As shown in the operation 1505, the detail information is presented by designating a block. The items of the information are different from those of the information which is given in the case of selecting day abscissa and the operation patter of the generators for a whole day is mainly presented.

Being same as in FIG. 13, it is possible to operation GUI to designate the amendment and change of Power Generator Operating Plan and Electric Power Trade Contract Plan in FIG. 14. For example, by narrowing the block of the Contracted Electric Power the operation 1506, it is designed such that a new electric power trade contract plan (under the bilateral sales contract) that has a new contract condition of shortened term for the supply corresponding to the size of the block and an automatic re-computation is carried out.

Moreover, it is possible to expand the data in a selected time abscissa after designating the time zone and to change the abscissa in day unit or monthly unit in FIG. 14, as well. As shown in 1507, by designating the expansion in date after selecting the time zone for 16 to 18 o'clock, the variation of a balance in such time zone against the date are computed and graphically compiled and presented. As explained above, it is possible to expand the data in a shorten time abscissa by designating the time zone.

As explained above, it is possible for the GUI operator with his arbitral aspects of interest to assess the balance regarding to the power generator operation plan and electric power trade contract plan that his company is planning and to assess the new balance estimation which has been updated in the plans, as well, without restrictions or difficulties. By iterating this sort of assessment, it is possible to survey and research the Power Generator Operating Plan and the Electric Power Trade Contract Plan that satisfy the requirements and the correlation between return and risk. When the operator judges himself that he acknowledges to have obtained the satisfactory solution, he inputs “No” at the step of Judgment on Necessary Input for Amendment. Then the latest updated Power Generator Operating Plan and Electric Power Trade Contract Plan stored in the internal data are adopted as a set of formal plans and the step goes to the next. Finally, the compilation of operation schedule and trade contract directive are processed at the stage 0114 of Generation of Operation Schedule Table and Trade Contract Directive Table and the compilation is over after printing out tho Power Station Operation Program and Electric Power Trade Contract Directive Bill.

By using this system, the operator can comprehend the correlation between return and risk that the present operating schedule potentially involves in a view of seasonal aspect and that of the time zone aspect. It is also possible to carry out the trial and error assessment of the plans under various conditions by supposing an adjusting of the operating schedule and the negotiation of bilateral trade condition that may eliminate the risk of the present operating plan. Especially, such assessment is useful and effective for the bilateral trade contract negotiation. In the trade negotiation, humanity always interferes the negotiation process therefore it is not always true that the conditions the operator desires can be executable. By using this invention, the operator can obtain, at arbitral time, useful parameters and indications regarding to the correlation between return and risk in the humanity process so that the contract condition is being decided.

In the above, the plurality of functions are explained each by each, however the execution is done in a complex functionalities of operation.

It is possible to make a set of dedicated equipment for this system. However, the above function can be realized by using a general computer system consists of the keyboard 1501, the main computer 1502 that has the input means that input the data and the computer programs, the storage that store the input data and computer programs, processing unit, the display unit and a computer programs working therein. FIG. 15 shows such dedicated computer equipment.

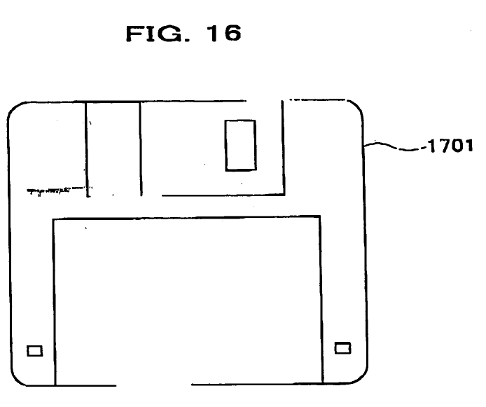

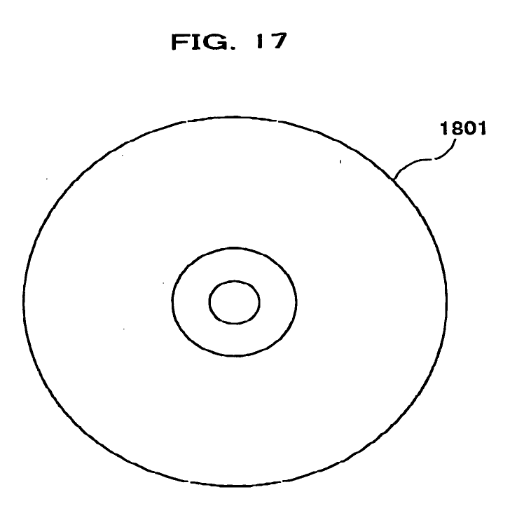

When the system is in service by installing the process program in the computation, the process programs are recorded in the floppy disk 1601 as shown in FIG. 16, in CD-ROM 1701 as shown in FIG. 17 and they can be delivered, archived, loaded and installed into the computer 1502 by reading the data by a magnetic disk drive and a CD-ROM drive. When the installation of the process program sent through the communication network is done by the input means, the installed program can be multiply used by storing in the magnetic disks.

The system regarding to this invention can provide a method, computer equipment and a program of the power generation plan and power generation trade plan that enable to comprehend the correlation between return and risk that the present operating schedule involves.

What is claimed is:

1. In a planning system that makes plans of electric power generation and electric power trade, a computer implemented method for an electric power generating plan and an electrical power trading plan comprising the steps of:
determining a stochastic distribution of uncertain factors included in an expected balance which is resulted from said electric power generating plan and said electric power trading plan, and
presenting said stochastic distribution of uncertain factors in a time-series form.

2. The computer implemented method of claim 1, wherein said electric power generating plan and said electric power trading plan are presented in time-series forms

3. The computer implemented method of claim 1, wherein said uncertainty factors are variances of electric power demand and prediction errors caused by annulment of electric power trading plan.

4. The computer implemented method of claim 1, wherein said uncertainty factors are variances of unit price of fuel to be used for power generators.

5. The computer implemented method of claim 1, wherein said uncertainty factors are variances of unit price of electric power to be traded.

6. The computer implemented method of claim 2, wherein said electric power generating plan and the electric power trading plan and said stochastic distribution are presented in a first chart that gives a time axis for an axis and generator power output, interruption term of power supply regarding to maintenance inspection, a term of output restriction and contracted electric power for the other axis and in a second chart that gives a time axis for an axis and expected value and variance of said stochastic distribution for another axis.

7. The computer implemented method of claim 6 comprising the steps of:
receiving designation of an area of blocks where power generator output is presented in said first chart thereof, and
presenting power generation volume, and power generator start stop term, in date output pattern and information of price variation of said fuel to be used.

8. The computer implemented method of claim 6 comprising the steps of:
receiving a designation of an area of blocks where an interruption term of power supply regarding to a maintenance inspection term and a restriction term of generator output is presented in said first step thereof, and
presenting said interruption term of power supply regarding to maintenance inspection, said restriction term of generator output or a generator output to be suppressed.

9. The computer implemented method of claim 6 comprising the steps of:
receiving designation of an area of blocks where in-trade electric power is presented in said fist chart thereof, and
presenting trade unit price, trade volume and in-date supply pattern.

10. The computer implemented method of claim 6 comprising the steps of:
receiving designation of an area of blocks where in-trade electric power is presented thereof, and
presenting expected values and variances of both unit price and volume of electric power to be traded for a term that said designation appoints.

11. The computer implemented method of claim 6 comprising the steps of:
receiving a term to be specified in said time axis, receiving a selection of an expanded scale or an shrunk scale of date or time zone of said term to be presented, and
presenting a chart composed on a time axis defined in said expanded scale or said shrunk scale.

12. The computer implemented method of claim 6 comprising the steps of:
receiving said generator output, a term to be specified in said time axis, said interruption term of power supply regarding to maintenance inspection, said term of output restriction and
determining a new said stochastic distribution, and
presenting the said new stochastic distribution in a time-series form.

13. In a planning computer equipment that makes electric power generating plan and electric power trading plan, said computer equipment comprising the devices of:
determining a stochastic distribution due to uncertain factors regarding to a balance caused by electric power generation and electric power trade, and
presenting said stochastic distribution in a time-series form.

14. In a computer program that has a function for planning computer equipment that makes electric power generating plan and electric power trading plan, said computer program comprising the program modules of:
determining a stochastic distribution due to uncertain factors regarding to a balance caused by electric power generation and electric power trade, and
presenting said stochastic distribution in a time-series form.

15. A computer readable recording medium to store and retrieve said program defined in claim 14.
